(19) United States
(12) Patent Application Publication
(10) Pub. No.: US 2014/0080710 A1
(43) Pub. Date: Mar. 20, 2014

(54) COMPOSITIONS WITH HOT MELT RESIN MATRIX

(71) Applicant: AgroFresh Inc., Spring House, PA (US)

(72) Inventors: Shiling Zhang, Shanghai (CN); Christian Guy Becker, King of Prussia, PA (US); Yunfei Yan, Shanghai (CN); Yongchun Chen, Shanghai (CN)

(21) Appl. No.: 14/029,454

(22) Filed: Sep. 17, 2013

Related U.S. Application Data
(63) Continuation-in-part of application No. PCT/CN2012/081468, filed on Sep. 17, 2012.
(60) Provisional application No. 61/713,924, filed on Oct. 15, 2012.

(51) Int. Cl. A01N 25/26

(52) U.S. Cl. CPC A01N 25/26
USPC 504/357; 504/359

(57) ABSTRACT

Provided are compositions comprising a collection of coated particles, wherein the coated particles comprises an active ingredient dispersed in an resin matrix; and a coating comprising at least one hydrophobic compound. Also provided are methods for preparing compositions comprising: (a) blending an active ingredient (for example, 1-MCP complex powder) with resin at the temperature slightly over the melting point of the resin; (b) dispersing the blend into an oil medium containing hydrophobic particles by shearing and obtain an oil dispersion; and (c) consolidating the resin particles by cooling. Thus, the active ingredient (for example, 1-MCP complex powder) is imbedded in the resin matrix spheres, and the hydrophobic particles, which also serve as Pickering emulsifier to stabilize the matrix spheres, form a coating layer around the matrix spheres to provide protection against water. Thus, the sphere is composed of the “Pickering” particle and resin matrix, in which the active ingredient is imbedded.

### BACKGROUND OF THE INVENTION

Ethylene is an important regulator for the growth, development, senescence, and environmental stress of plants, mainly affecting related processes of plant ripening, flower senescence and leaf abscission. Ethylene is usually generated in large amounts during growth of plants under environmental stress or during preservation and delivery of plants. Therefore yield of plants such as fruit and crop can be reduced under heat or drought stress before harvesting. The commercial value of fresh plants such as vegetables, fruits and flowers after harvesting is reduced by excessive ethylene gas which hastens the ripening of fruits, the senescence of flowers and the early abscission of leaves.

To prevent the adverse effects of ethylene, 1-methylcyclopropene (1-MCP) is used to occupy ethylene receptor and therefore ethylene cannot bind and elicit action. The affinity of 1-MCP for the receptor is approximately 10 times greater than that of ethylene for the receptor. 1-MCP also influences biosynthesis in some species through feedback inhibition. Thus, 1-MCP is widely used for fresh retention post-harvest and plant protection pre-harvest.

But 1-MCP is difficult to handle because it is gas with high chemical activity. To overcome this problem, 1-MCP gas has been encapsulated successfully by oil-in-water emulsion with 1-MCP gas dissolved in internal oil phase, but 1-MCP concentration in final product is still low (<50 ppm).

Therefore, in current agricultural applications, 1-MCP is complexed with cyclodextrin to form a powder, and 1-MCP can be released as a gas when the powder is dissolved in water. The powder products are much more convenient to use than products in gas form, but they still have disadvantages including: (1) it is not user-friendly when handling powder in the field or in an enclosed space; (2) the powder form cannot stably and uniformly be suspend in water, which leads to non-uniform delivery of 1-MCP to plants and uneven ripening response of plants; and (3) after contact with water, 1-MCP is released completely within a short period of time, much earlier than desired, some or all of 1-MCP is thus lost to the surroundings. Therefore, 1-MCP powder products are not properly formulated for use in water that is suitable for delaying plant maturation in the field.

In addition, efforts to solve above problems include mixing 1-MCP complex powder with other powders form materials, then preparing effervescent tablets or enclosing the mixture in a water impermeable container. But such modified compositions still have disadvantages including: (1) similar to the limitations of powders, they are still limited in applications since they usually require air circulation to ensure uniform distribution of 1-MCP, which is not available in field application; and (2) they cannot be used by spraying in the field. Thus, there remains a need for compositions for delivery of compounds including cyclopropenes or other plant growth regulators without these disadvantages.

### SUMMARY OF THE INVENTION

Provided are compositions comprising a collection of coated particles, wherein the coated particles comprises an active ingredient dispersed in an resin matrix; and a coating comprising at least one hydrophobic compound. Also provided are methods for preparing compositions comprising: (a) blending an active ingredient (for example, 1-MCP complex powder) with resin at the temperature slightly over the melting point of the resin; (b) dispersing the blend into an oil medium containing hydrophobic particles by shearing and obtain an oil dispersion; and (c) consolidating the resin particles by cooling. Thus, the active ingredient (for example, 1-MCP complex powder) is imbedded in the resin matrix spheres, and the hydrophobic particles, which also serve as Pickering emulsifier to stabilize the matrix spheres, form a coating layer around the matrix spheres to provide protection against water. Thus, the sphere is composed of the “Pickering” particle and resin matrix, in which the active ingredient is imbedded.

In one aspect, provided is a composition comprising a collection of coated particles, wherein each of the coated particles comprises,

(a) an active ingredient dispersed in an resin matrix; and

(b) a coating comprising at least one hydrophobic compound.

In one embodiment of the compositions provided, the active ingredient comprises a volatile compound. In a further embodiment, the volatile compound comprises a cyclopropene. In one embodiment, the cyclopropene is of the formula:

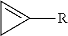

wherein R is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy. In a further embodiment, R is C₁₋₈ alkyl. In a further embodiment, R is methyl.

In another embodiment, the cyclopropene is of the formula:

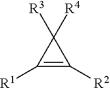

wherein R¹ is a substituted or unsubstituted C₁-C₄ alkyl, C₁-C₄ alkenyl, C₁-C₄ alkynyl, C₁-C₄ cylcoalkyl, cylcoalkylalkyl, phenyl, or napthyl group; and R², R³, and R⁴ are hydrogen. In a further embodiment, the cyclopropene comprises 1-methylcyclopropene (1-MCP). In another embodiment, the active ingredient comprises a complex comprising a cyclopropene and a molecular encapsulating agent. In a further embodiment, the molecular encapsulating agent comprises alpha-cyclodextrin, beta-cyclodextrin, gamma-cyclodextrin, or combinations thereof. In a further embodiment, the molecular encapsulating agent comprises alpha-cyclodextrin.

In one embodiment, the active ingredient comprises a plant growth regulator. In another embodiment the resin matrix comprises polyester resins. In another embodiment, the resin matrix comprises polyester, polyether, epoxy resin, isocyanate, ethylene vinyl acetate copolymer, natural or synthesized wax, or combinations thereof. In another embodiment, the resin matrix comprises polycaprolactone polyols.

In one embodiment, the polycaprolactone polyols have molecular weight from 1,000 to 200,000; from 2,000 to 50,000; from 2,000 to 8,000; or from 2,000 to 4,000. In another embodiment, the polycaprolactone polyols have a melting point from 30° C. to 120° C.; from 40° C. to 80° C.; or from 50° C. to 60° C. In another embodiment, the at least one hydrophobic compound comprises hydrophobic silica. In a further embodiment, silica surface of the hydrophobic silica is modified by silane coupling agent or organosilicon. In another embodiment, the at least one hydrophobic compound comprises hydrophobic particles. In a further embodiment, the hydrophobic particles function as Pickering emulsifier and comprise silica particles, clay, oxides, polymer particles, or combinations thereof.

In one embodiment, particle sizes of the coated particles are from 10 nanometers to 200 microns. In a further embodiment, particle sizes of the coated particles are from 10 nanometers to 10 microns. In another further embodiment, particle sizes of the coated particles are from 100 nanometers to 5 microns. In another further embodiment, particle sizes of the coated particles are from 5 microns to 200 microns. In another embodiment, the composition provided further comprising at least one surfactant. In another embodiment, the composition provided does not comprise a surfactant. In another embodiment, the at least one surfactant comprises anionic surfactant, nonionic surfactant, or combinations thereof. In a further embodiment, the at least one surfactant comprises an ionic surfactant selected from the group consisting of sulfate salt, sulfonate salt, and combinations thereof. In another further embodiment, the at least one surfactant comprises a nonionic surfactant selected from the group consisting of ethoxylates of fatty alcohol, ethoxylate of fatty acids, block copolymer of polyoxyethylene and polyolefin, and combinations thereof. In another embodiment, ratio of the active ingredient to the resin matrix is from about 1:1 to about 1:100. In another embodiment, ratio of the active ingredient to the resin matrix is from about 1:2 to about 1:100. In another embodiment, ratio of the active ingredient to the resin matrix is at least 1:1. In another embodiment, ratio of the active ingredient to the resin matrix is less than 1:100.

In another aspect, provided is method for preparing a composition, comprising,
(a) blending an active ingredient with resin at a temperature higher than melting point of the resin;
(b) dispersing the blend of step (a) into an oil medium containing hydrophobic particles; and
(c) consolidating Pickering particles by cooling to a temperature lower than the melting point of the resin.

In one embodiment, the oil medium comprises a mixture of alkanes of C14 to C50, or a distillate of petroleum. In another embodiment, the oil medium comprises mineral oil, light mineral oils, Isopar oil, Unipar oil and other hydrocarbon oils, edible oils, or combinations thereof. In another embodiment, the temperature lower than the melting point of the resin is ambient temperature. In another embodiment, ratio of the Pickering particles to the oil medium is from about 1:5 to about 1:25. In another embodiment, ratio of the Pickering particles to the oil medium is from about 1:10 to about 1:24. In another embodiment, ratio of the resin matrix to the oil medium is from about 2:1 to about 1:100. In another embodiment, ratio of the resin matrix to the oil medium is from about 1:1 to about 1:100. In another embodiment, ratio of the active ingredient to the resin matrix is from about 1:1 to about 1:100. In another embodiment, ratio of the active ingredient to the resin matrix is from about 1:2 to about 1:100. In another embodiment, ratio of the active ingredient to the resin matrix is at least 1:1. In another embodiment, ratio of the active ingredient to the resin matrix is less than 1:100.

In one embodiment of the methods provided, the active ingredient comprises a volatile compound. In a further embodiment, the volatile compound comprises a cyclopropene. In one embodiment, the cyclopropene is of the formula:

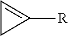

wherein R is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy. In a further embodiment, R is C₁₋₈ alkyl. In a further embodiment, R is methyl.

In another embodiment, the cyclopropene is of the formula:

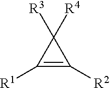

wherein R¹ is a substituted or unsubstituted C₁-C₄ alkyl, C₁-C₄ alkenyl, C₁-C₄ alkynyl, C₁-C₄ cylcoalkyl, cylcoalkylalkyl, phenyl, or napthyl group; and R², R³, and R⁴ are hydrogen. In a further embodiment, the cyclopropene comprises 1-methylcyclopropene (1-MCP). In another embodiment, the active ingredient comprises a complex comprising a cyclopropene and a molecular encapsulating agent. In a further embodiment, the molecular encapsulating agent comprises alpha-cyclodextrin, beta-cyclodextrin, gamma-cyclodextrin, or combinations thereof. In a further embodiment, the molecular encapsulating agent comprises alpha-cyclodextrin.

In another aspect, provided is a slurry comprising an aqueous medium and a collection of coated particles, wherein each of the coated particles comprises,

(a) an active ingredient dispersed in an resin matrix; and

(b) a coating comprising at least one hydrophobic compound.

In one embodiment of the slurries provided, the active ingredient comprises a volatile compound. In a further embodiment, the volatile compound comprises a cyclopropene. In a further embodiment, the cyclopropene comprises 1-methylcyclopropene (1-MCP). In another embodiment, the active ingredient comprises a complex comprising a cyclopropene and a molecular encapsulating agent. In a further embodiment, the molecular encapsulating agent comprises alpha-cyclodextrin, beta-cyclodextrin, gamma-cyclodextrin, or combinations thereof. In another embodiment, the slurry comprises the composition provided herein.

In another aspect, provided is a method of treating plants or plant parts comprising contacting said plants or plant parts with a slurry comprising an aqueous medium and a collection of coated particles, wherein each of the coated particles comprises,

(a) an active ingredient dispersed in an resin matrix; and

(b) a coating comprising at least one hydrophobic compound.

In one embodiment of the method provided, the active ingredient comprises a volatile compound. In a further embodiment, the volatile compound comprises a cyclopropene. In a further embodiment, the cyclopropene comprises 1-methylcyclopropene (1-MCP). In another embodiment, the active ingredient comprises a complex comprising a cyclopropene and a molecular encapsulating agent. In a further embodiment, the molecular encapsulating agent comprises alpha-cyclodextrin, beta-cyclodextrin, gamma-cyclodextrin, or combinations thereof. In another embodiment, the method uses the composition provided herein.

### BRIEF DESCRIPTION OF THE DRAWINGS

FIG. 1 shows representative coated particles of the composition provided herein, showing Pickering stabilization structure using hydrophobic particles. HAIP refers to 1-methylcyclopropene/alpha-cyclodextrin complex.

FIG. 2 shows representative release profile of 1-methylcyclopropene (1-MCP). FIG. 2A shows release rate of HAIP in water at ambient temperature. FIG. 2B shows emulsified HAIP and oil in water at different temperature for thirty (30) minutes.

FIG. 3 shows representative release profile of 1-MCP from Sample #1 and Sample #2 upon dilution with water at ambient temperature for different time: FIG. 3A at 5-360 minutes; and FIG. 3B at 5-4200 minutes.

FIG. 4 shows representative release profile of 1-MCP from Sample #5 upon dilution with water at ambient temperature for different time: FIG. 4A 5-360 minutes; and FIG. 4B at 5-1100 minutes.

FIG. 5 shows representative release profile of 1-MCP released from Sample #3 and Sample #4 upon dilution with water: FIG. 5A at 5-360 minutes at ambient temperature; FIG. 5B at 5-4000 minutes at ambient temperature; and FIG. 5C at 30 minutes at 70° C.

FIG. 6 shows representative SEM images of Sample #1 (FIGS. 6a, 6b, and 6c); Sample #2 (FIGS. 6d, 6e, and 6f); and Sample #4 (FIGS. 6g, 6h, and 6i).

### DETAILED DESCRIPTION OF THE INVENTION

Provided are methods for preparing compositions comprising: (1) blending an active ingredient (for example, 1-MCP complex powder) with resin at the temperature slightly over the melting point of the resin; (2) dispersing the blend into an oil medium containing hydrophobic particles by shearing and obtain an oil dispersion; (3) consolidating the resin particles by cooling. Thus, the active ingredient (for example, 1-MCP complex powder) is imbedded in the resin matrix spheres, and the hydrophobic particles, which also serve as Pickering emulsifier to stabilize the matrix spheres, form a coating layer around the matrix spheres to provide protection against water. Thus, the sphere is composed of the “Pickering” particle and resin matrix, in which the active ingredient is imbedded.

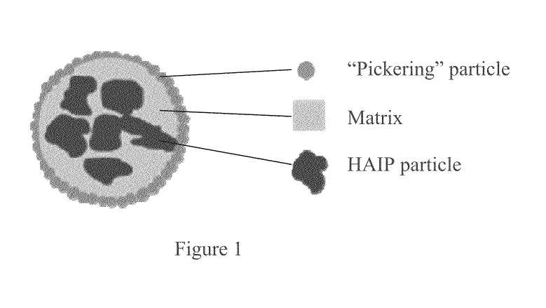

Also provided are compositions prepared using the methods provided herein. A representative morphology of the spheres produced by the methods provided is illustrated in FIG. 1. As the sample is diluted with water, water needs to go through the hydrophobic coating layer and penetrate into the resin matrix, interacts with the imbedded active ingredient (for example, 1-MCP complex powder), and releases the active ingredient (for example, 1-MCP) from the complex. Thus, compared to unprotected (or uncoated) 1-MCP complex powder, slow release of 1-MCP can be achieved upon dilution with water. That also allows uniform delivery of 1-MCP to plants, permitting effective and consistent use in field conditions, and offering significant improvement in regulating plant physiology.

Suitable oil medium may include mineral oil, which may comprise light mixtures of alkanes in the C15 to C40 range, or a distillate of petroleum. Suitable oil includes, but is not limited to, mineral oil, light mineral oils, Isopar oil, Unipar oil and other hydrocarbon oils, edible oils and mixture thereof.

Suitable polyester resins include polycaprolactone polyols. Typical molecular weight may be from 1,000 to 200,000; from 2,000 to 50,000; from 2,000 to 8,000; or from 2,000 to 4,000. Typically, the polycaprolactone polyols have a melting point from 30° C. to 120° C.; from 40° C. to 80° C.; or from 50° C. to 60° C. For example, resins including PCL with molecular weight about 120,000 can have a melting point about 60° C. In one embodiment, this kind of resin with a 60° C. melting point is useful for the subject invention. 1-methylcyclopropene/alpha-cyclodextrin complex (HAIP) is known to tolerate temperature about 100° C. for a short duration (for example four minutes) without significant activity loss. In one embodiment, process temperature is slightly higher than the melting point of the resin and the process time is less than twenty minutes.

Suitable hydrophobic compounds or hydrophobic particles include hydrophobic silica, where silica surface may be modified by silane coupling agent or organosilicon. Primary particle size may be from about 10 nanometers to several microns.

Suitable resins are not limited to the pure polymer resin with the same chemicals structures or same molecule weight, but can also include blends of several resins. And resin category that is suitable use in the present invention includes, but is not limited to, polyester, polyether, epoxy resin, isocyanate, ethylene vinyl acetate copolymer, natural or synthesized wax, and mixture thereof. But at least one component of the resins has relatively strong interaction with HAIP, so that HAIP particles can be detained within the resin matrix. In one embodiment, the resin has a melting point below 100° C., and a viscosity below 10,000 centipoises, so that it can be blended with HAIP powder and dispersed into oil medium easily.

Hydrophobic particles herein suitable as Pickering emulsifier include, but not limited to, silica particles, clay, oxides, polymer particles and mixture thereof. On the other hand, conventional surfactants are optional to assist the formation of a stable suspension of particles in oil. Suitable surfactants include, for example, anionic surfactants, nonionic surfactants, and mixtures thereof. Some suitable anionic surfactants include, but not limited to, sulfates, and the sulfonates. Some suitable nonionic surfactants include, but not limited to, ethoxylates of fatty alcohols, ethoxylates of fatty acids, block copolymer of polyoxyethylene and polyolefin, and mixture thereof.

The step of consolidating particles is suitable for use in the present invention includes, but it not limited to, cooling down to ambient temperature. The ratio of the Pickering particle powder to the oil may be from about 1:5 to about 1:25; or from about 1:10 to about 1:24. The ratio of the HAIP powder to resins may be from about 1:1 to 1:100; or from about 1:2: to about 1:100. The ratio of the resins to the oil may be from about 2:1 to about 1:100; or from about 1:1 to about 1:100.

As used herein, the phrase “Polymer” refers to a relatively large molecule made up of the reaction products of smaller chemical repeat units. The repeat units (also called “monomer units”) are residues of monomer molecules. The repeat units may be all identical or may include two or more different repeat units. Polymer molecules may have any structure including, for example, linear, branched, star-shaped, crosslinked, and mixtures thereof. Polymer molecular weights can be measured by standard methods such as, for example, size exclusion chromatography (SEC, also called gel permeation chromatography or GPC). Polymers have number-average molecular weight (Mn) of greater than 700. “Oligomer” as used herein is also a molecule made up of the reaction products of smaller chemical repeat units called monomer units. Oligomers have molecular weight of 700 or less.

Thermoset polymers can be fully crosslinked. Thermoset polymers cannot be molded into new shapes by the application of heat and pressure, and thermoset polymers cannot be dissolved in any solvent. Polymers that are not thermoset are called thermoplastic polymers.

As used herein, a material is water-insoluble if the amount of that material that can be dissolved in water at 25° C. is 1 gram of material or less per 100 grams of water.

As used herein, when reference is made to a collection of powder particles, the phrase “most or all of the powder particles” means 50% to 100% of the powder particles, by weight based on the total weight of the collection of powder particles.

As used herein, a “solvent compound” is a compound that has boiling point at one atmosphere pressure of between 20° C. and 200° C. and that is liquid at one atmosphere pressure over a range of temperatures that includes 20° C. to 30° C. A “solvent” can be a solvent compound or a mixture of solvents. A non-aqueous solvent can be a solvent that either contains no water or that contains water in an amount of 10% or less by weight based on the weight of the solvent.

As used herein, the phrase “aqueous medium” refers to a composition that is liquid at 25° C. and that contains 75% or more water by weight, based on the weight of the aqueous medium. Ingredients that are dissolved in the aqueous medium are considered to be part of the aqueous medium, but materials that are not dissolved in the aqueous medium are not considered to be part of the aqueous medium. An ingredient is “dissolved” in a liquid if individual molecules of that ingredient are distributed throughout the liquid and are in intimate contact with the molecules of the liquid.

As used herein, when any ratio is said to be X:1 or higher, that ratio is meant to be Y:1, where Y is X or higher. Similarly, when any ratio is said to be R:1 or lower, that ratio is meant to be S:1, where S is R or lower.

As used herein, the “aspect ratio” of a solid particle is the ratio of the particle's longest dimension to that particle's shortest dimension. A particle's longest dimension is the length of the longest possible line segment (“segment L”) that passes through the particle's center of mass and that has each of its end points on the surface of the particle. That particle's shortest dimension is the length of the shortest possible line segment (“segment S”) that passes through the particle's center of mass, that has each of its end points on the surface of the particle, and that is perpendicular to segment L. The aspect ratio is the ratio of the length of segment L to the length of segment S.

As used herein, the “diameter” of a particle is the average of the length of that particle's segment L and that particle's segment S. It is noted that, when the particle is spherical, this definition gives the “diameter” in the usual sense.

As used herein, when a property of a powder is described as having a “median” value, it is contemplated that half of the total volume of powder particles will consist of particles that have that property with value above that median value and that half of the total volume of powder particles will consist of particles that have property with value below that median value.

The practice of the present invention involves the use of one or more cyclopropene compound. As used herein, a cyclopropene compound is any compound with the formula

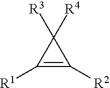

where each R¹, R², R³ and R⁴ is independently selected from the group consisting of H and a chemical group of the formula:

-(L)ₙ-Z

where n is an integer from 0 to 12. Each L is a bivalent radical. Suitable L groups include, for example, radicals containing one or more atoms selected from H, B, C, N, O, P, S, Si, or mixtures thereof. The atoms within an L group may be connected to each other by single bonds, double bonds, triple bonds, or mixtures thereof. Each L group may be linear, branched, cyclic, or a combination thereof. In any one R group (i.e., any one of R¹, R², R³ and R⁴) the total number of heteroatoms (i.e., atoms that are neither H nor C) is from 0 to 6. Independently, in any one R group the total number of non-hydrogen atoms is 50 or less. Each Z is a monovalent radical. Each Z is independently selected from the group consisting of hydrogen, halo, cyano, nitro, nitroso, azido, chlorate, bromate, iodate, isocyanato, isocyanido, isothiocyanato, pentafluorothio, and a chemical group G, wherein G is a 3 to 14 membered ring system.

The R¹, R², R³, and R⁴ groups are independently selected from the suitable groups. Among the groups that are suitable for use as one or more of R¹, R², R³, and R⁴ are, for example, aliphatic groups, aliphatic-oxy groups, alkylphosphonato groups, cycloaliphatic groups, cycloalkylsulfonyl groups, cycloalkylamino groups, heterocyclic groups, aryl groups, heteroaryl groups, halogens, silyl groups, other groups, and mixtures and combinations thereof. Groups that are suitable for use as one or more of R¹, R², R³, and R⁴ may be substituted or unsubstituted.

Among the suitable R¹, R², R³, and R⁴ groups are, for example, aliphatic groups. Some suitable aliphatic groups include, for example, alkyl, alkenyl, and alkynyl groups. Suitable aliphatic groups may be linear, branched, cyclic, or a combination thereof. Independently, suitable aliphatic groups may be substituted or unsubstituted.

As used herein, a chemical group of interest is said to be “substituted” if one or more hydrogen atoms of the chemical group of interest is replaced by a substituent.

Also among the suitable R¹, R², R³, and R⁴ groups are, for example, substituted and unsubstituted heterocyclyl groups that are connected to the cyclopropene compound through an intervening oxy group, amino group, carbonyl group, or sulfonyl group; examples of such R¹, R², R³, and R⁴ groups are heterocyclyloxy, heterocyclylcarbonyl, diheterocyclylamino, and diheterocyclylaminosulfonyl.

Also among the suitable R¹, R², R³, and R⁴ groups are, for example, substituted and unsubstituted heterocyclic groups that are connected to the cyclopropene compound through an intervening oxy group, amino group, carbonyl group, sulfonyl group, thioalkyl group, or aminosulfonyl group; examples of such R¹, R², R³, and R⁴ groups are diheteroarylamino, heteroarylthioalkyl, and diheteroarylaminosulfonyl.

Also among the suitable R¹, R², R³, and R⁴ groups are, for example, hydrogen, fluoro, chloro, bromo, iodo, cyano, nitro, nitroso, azido, chlorato, bromato, iodato, isocyanato, isocyanido, isothiocyanato, pentafluorothio; acetoxy, carboethoxy, cyanato, nitrato, nitrito, perchlorato, allenyl, butylmercapto, diethylphosphonato, dimethylphenylsilyl, isoquinolyl, mercapto, naphthyl, phenoxy, phenyl, piperidino, pyridyl, quinolyl, triethylsilyl, trimethylsilyl; and substituted analogs thereof.

As used herein, the chemical group G is a 3 to 14 membered ring system. Ring systems suitable as chemical group G may be substituted or unsubstituted; they may be aromatic (including, for example, phenyl and napthyl) or aliphatic (including unsaturated aliphatic, partially saturated aliphatic, or saturated aliphatic); and they may be carbocyclic or heterocyclic. Among heterocyclic G groups, some suitable heteroatoms are, for example, nitrogen, sulfur, oxygen, and combinations thereof. Ring systems suitable as chemical group G may be monocyclic, bicyclic, tricyclic, polycyclic, spiro, or fused; among suitable chemical group G ring systems that are bicyclic, tricyclic, or fused, the various rings in a single chemical group G may be all the same type or may be of two or more types (for example, an aromatic ring may be fused with an aliphatic ring).

In one embodiment, one or more of R¹, R², R³, and R⁴ is hydrogen or (C₁-C₁₀) alkyl. In another embodiment, each of R¹, R², R³, and R⁴ is hydrogen or (C₁-C₈) alkyl. In another embodiment, each of R¹, R², R³, and R⁴ is hydrogen or (C₁-C₄) alkyl. In another embodiment, each of R¹, R², R³, and R⁴ is hydrogen or methyl. In another embodiment, R¹ is (C₁-C₄) alkyl and each of R², R³, and R⁴ is hydrogen. In another embodiment, R¹ is methyl and each of R², R³, and R⁴ is hydrogen, and the cyclopropene compound is known herein as 1-methylcyclopropene or “1-MCP.”

In one embodiment, a cyclopropene compound can be used that has boiling point at one atmosphere pressure of 50° C. or lower, 25° C. or lower; or 15° C. or lower. In another embodiment, a cyclopropene compound can be used that has boiling point at one atmosphere pressure of −100° C. or higher, −50° C. or higher; −25° C. or higher; or 0° C. or higher.

The composition of the present invention includes at least one molecular encapsulating agent. In preferred embodiments, at least one molecular encapsulating agent encapsulates one or more cyclopropene compound or a portion of one or more cyclopropene compound. A complex that contains a cyclopropene compound molecule or a portion of a cyclopropene compound molecule encapsulated in a molecule of a molecular encapsulating agent is known herein as a “cyclopropene compound complex.”

In one embodiment, at least one cyclopropene compound complex is present that is an inclusion complex. In a further embodiment for such an inclusion complex, the molecular encapsulating agent forms a cavity, and the cyclopropene compound or a portion of the cyclopropene compound is located within that cavity.

In another embodiment for such inclusion complexes, the interior of the cavity of the molecular encapsulating agent is substantially apolar or hydrophobic or both, and the cyclopropene compound (or the portion of the cyclopropene compound located within that cavity) is also substantially apolar or hydrophobic or both. While the present invention is not limited to any particular theory or mechanism, it is contemplated that, in such apolar cyclopropene compound complexes, van der Waals forces, or hydrophobic interactions, or both, cause the cyclopropene compound molecule or portion thereof to remain within the cavity of the molecular encapsulating agent.

The amount of molecular encapsulating agent can usefully be characterized by the ratio of moles of molecular encapsulating agent to moles of cyclopropene compound. In one embodiment, the ratio of moles of molecular encapsulating agent to moles of cyclopropene compound can be 0.1 or larger; 0.2 or larger. 0.5 or larger; or 0.9 or larger. In another embodiment, the ratio of moles of molecular encapsulating agent to moles of cyclopropene compound can be 10 or lower; 5 or lower; 2 or lower, or 1.5 or lower.

Suitable molecular encapsulating agents include, for example, organic and inorganic molecular encapsulating agents. Suitable organic molecular encapsulating agents, which include, for example, substituted cyclodextrins, unsubstituted cyclodextrins, and crown ethers. Suitable inorganic molecular encapsulating agents include, for example, zeolites. Mixtures of suitable molecular encapsulating agents are also suitable. In one embodiment, the encapsulating agent is alpha-cyclodextrin, beta-cyclodextrin, gamma-cyclodextrin, or combinations thereof. In a further embodiment, alpha-cyclodextrin is used.

In one embodiment, complex powders may have median particle diameter of 10 micrometers or less; 7 micrometers or less; or 5 micrometers or less. In another embodiment, complex powders may have median particle diameter of 0.1 micrometer or more; or 0.3 micrometer or more. Median particle diameter may be measured by light diffraction using a commercial instrument such as those manufactured, for example, by Horiba Co. or Malvern Instruments.

In another embodiment, complex powders may have median aspect ratio of 5:1 or lower; 3:1 or lower; or 2:1 or lower. If a complex powder is obtained that has undesirably high median aspect ratio, mechanical means may be used, for example, milling, to reduce the median aspect ratio to a desirable value.

In one embodiment, suitable resins may have melting point of 55° C. or higher; 65° C. or higher; or 70° C. or higher. In another embodiment, suitable resins may have melting point of 100° C. or lower; or 90° C. or lower.

Another method of assessing fatty compounds is the temperature of onset of the melting point. To determine the onset temperature, the exotherm curve (heat flow vs. temperature) produced by the DSC for the melting point transition is observed. The baseline is determined, and a corrected heat-flow curve calculated by subtracting the baseline from the original heat-flow curve. The maximum heat-flow value of the corrected curve (HFMAX) is determined. The onset temperature is the lowest temperature at which the heat-flow value on the corrected curve is equal to 0.1*HFMAX. Suitable resins may have onset temperature of 45° C. or higher; or 55° C. or higher.

One useful way to characterize the powder composition of the present invention is the median particle diameter, which may be 100 micrometers or less; 75 micrometers or less; 50 micrometers or less; or 25 micrometers or less.

The composition of the present invention may be used for treating plants or plant parts in any way. For example, the composition may be mixed with other materials or may be used directly.

Provided is a method of using the composition of the present invention for a formation of an aqueous slurry. An aqueous slurry can be formed when the composition provided is mixed with an aqueous medium. To form such a slurry, the aqueous medium may be mixed directly with the composition of the present invention. It is expected that the coated particles of the composition provided remain intact in the slurry. It is also contemplated that most or all of the coated particles will be dispersed in the slurry as individual particles rather than as agglomerates thereof. The coated particles may require mechanical agitation to remain suspended in the aqueous medium, or they may remain suspended without agitation.

The amount of composition provided in the slurry may be characterized by the concentration of cyclopropene compound in the slurry. In one embodiment, suitable slurries may have cyclopropene compound concentration, in units of milligrams of cyclopropene compound per liter of slurry, of 2 or higher; 5 or higher; or 10 or higher. In another embodiment, suitable slurries may have cyclopropene compound concentration, in units of milligrams of cyclopropene compound per liter of slurry, of 1000 or lower; 500 or lower; or 200 or lower.

The amount of water in the aqueous medium used in the slurry may be, by weight based on the weight of aqueous medium, 80% or more; 90% or more; or 95% or more.

The slurry may optionally contain one or more adjuvants, for example, one or more metal complexing agent, one or more surfactant, one or more oil, one or more alcohol, or mixtures thereof. Examples of metal-complexing agents, if used, include chelating agents. Examples of surfactants, if used, include anionic surfactants and silicone surfactants. Examples of alcohols, if used, include alkyl alcohols with 4 or fewer carbon atoms. Oils are compounds that are liquid at 25° C., are not water, are not surfactants, and are not alcohols. Examples of oils, if used, include hydrocarbon oils and silicone oils.

Also provided is a method of treating plants by bringing the slurry into contact with plants or plant parts. Such contacting may be performed in any location, including inside enclosed spaces (for example, containers, rooms, or buildings) or outside of an enclosed space. In one embodiment, such contacting is performed outside of any enclosed space. As used herein, “outside of any enclosed space” means outside of any building or enclosure or else in a room or building that is ventilated to outdoor atmosphere. In another embodiment, such contacting is performed outside of any building or enclosure. In a further embodiment, such contacting is performed in an outdoor field or plot.

The slurry of the present invention may be brought into contact with plants or plant parts by methods known in the art. Examples of methods include dipping plant parts into the slurry and applying slurry to plants or plant parts by spraying, foaming, brushing, or combinations thereof. Other examples include spraying the slurry onto plants or plant parts and dipping plant parts into the slurry. Additional examples include spraying the slurry onto plants or plant parts.

Plants or plant parts may be treated in the practice of the present invention. One example is treatment of whole plants; another example is treatment of whole plants while they are planted in soil, prior to the harvesting of useful plant parts.

Any plants that provide useful plant parts may be treated in the practice of the present invention. Examples include plants that provide fruits, vegetables, and grains.

As used herein, the phrase “plant” includes dicotyledons plants and monocotyledons plants. Examples of dicotyledons plants include tobacco, Arabidopsis, soybean, tomato, papaya, canola, sunflower, cotton, alfalfa, potato, grapevine, pigeon pea, pea, Brassica, chickpea, sugar beet, rapeseed, watermelon, melon, pepper, peanut, pumpkin, radish, spinach, squash, broccoli, cabbage, carrot, cauliflower, celery, Chinese cabbage, cucumber, eggplant, and lettuce. Examples of monocotyledons plants include corn, rice, wheat, sugarcane, barley, rye, sorghum, orchids, bamboo, banana, cattails, lilies, oat, onion, millet, and triticale.

As used herein, the phase “plant growth regulator” includes, but not limited to, ethylene, cyclopropenes, glyphosate, glufosinate, and 2,4-D. Other suitable plant growth regulators have been disclosed in International Patent Application Publication WO 2008/071714A1, which is incorporated by reference in its entirety.

Additional suitable plant growth regulators include famoxadone; or carboxylic amides selected from benalaxyl, benodanil, boscalid, carboxin, mepronil, fenfuram, fenhexamid, flutolanil, furametpyr, metalaxyl, ofurace, oxadixyl, oxycarboxin, penthiopyrad, thifluzamid, tiadinil, 4-difluoromethyl-2-methyl-thiazol-5-carboxylic acid-(4′-bromo-biphenyl-2-yl)-amide, 4-difluoromethyl-2-methyl-thiazol-5-carboxylic acid-(4′-trifluoromethyl-biphenyl-2-yl)-amide, 4-difluoromethyl-2-methyl-thiazol-5-carboxylic acid-(4′-chloro-3′-fluoro-biphenyl-2-yl)-amide, 3-difluoromethyl-1-methyl-pyrazol-4-carboxylic acid-(3′,4′-dichloro-4-fluoro-biphenyl-2-yl)-amide, 3,4-dichloro-isothiazol-5-carboxylic acid-(2-cyano-phenyl)-amide, dimethomorph, flumorph, flumetover, fluopicolide (picobenzamid), zoxamide, carpropamide, diclocymet, mandipropamid, N-(2-(4-[3-(4-chloro-phenyl)-prop-2-inyloxy]-3-methoxy-phenyl)-ethyl)-2-methanesulfo-nylamino-3-methyl-butyramid and N-(2-(4-[3-(4-chloro-phenyl)-prop-2-inyloxy]-3-methoxy-phenyl)-ethyl)-2-ethanesulfonylamino-3-methyl-butyramide.

Additional suitable plant growth regulators include azoles selected from bitertanole, bromuconazole, cyproconazole, difenoconazole, diniconazole, enilconazole, epoxiconazole, fenbuconazole, flusila-zole, fluquinconazole, flutriafol, hexaconazole, imibenconazole, ipconazole, metconazole, myclobutanil, penconazole, propiconazole, prothioconazole, simeconazole, tebuconazole, tetraconazole, triadimenol, triadimefon, triticona-zole, cyazofamid, imazalil, pefurazoate, prochloraz, triflumizol, benomyl, carbendazim, fuberidazole, thiabendazole, ethaboxam, etridiazole and hymexa-zole; and nitrogen-containing heterocyclic compounds selected from fluazinam, pyrifenox, 3-[5-(4-chloro-phenyl)-2,3-dimethyl-isoxazolidin-3-yl]-pyridine, bupirimat, cyprodinil, ferimzon, fenarimol, mepanipyrim, nuarimol, pyrimethanil, tri-forin, fludioxonil, fenpiclonil, aldimorph, dodemorph, fenpropimorph, tridemorph, iprodion, procymidon, vinclozolin, acibenzolar-5-methyl, anilazin, captan, captafol, dazomet, diclomezine, fenoxanil, folpet, fenpropidin, famoxadone, fenamidone, octhilinon, probenazol, proquinazid, pyroquilon, quinoxyfen, tricyclazol, 2-butoxy-6-iodo-3-propyl-chromen-4-one, 3-(3-bromo-6-fluoro-2-methyl-indole-1-sulfonyl)-[1,2,4]triazole-1-sulfonic acid dimethylamide.

Additional suitable plant growth regulators include carbamates and dithiocarbamates selected from ferbam, mancozeb, metiram, metam, propineb, thiram, zineb, ziram, diethofencarb, flubenthiavalicarb, iprovalicarb, propamocarb, 3-(4-chloro-phenyl)-3-(2-isopropoxy carbonylamino-3-methyl-butyrylamino)-propionic acid methylester and N-(1-(1-(4-cyanophenyl)ethanesulfonyl)-but-2-yl)carbamic acid-(4-fluorophenyl)ester; guanidines selected from dodin, iminoctadine and guazatin; and antibiotics selected from kasugamycin, polyoxine, streptomycin and valida-mycin A.

Additional suitable plant growth regulators include fentin salts; sulfur-containing heterocyclic compounds selected from isoprothiolan and dithianon; organophosphorous compounds selected from edifenphos, fosetyl, fosetyl-aluminium, iprobenfos, pyrazophos, tolclofos-methyl, phosphoric acid and the salts thereof; organo-chloro compounds selected from thiophanate methyl, chlorothalonil, dichlofluanid, tolylfluanid, flusulfamid, phthalide, hexachlorbenzene, pency-curon, quintozen; nitrophenyl derivatives selected from binapacryl, dinocap and dinobuton; and inorganic active ingredients selected from Bordeaux composition, copper acetate, copper hydroxide, copper oxychloride, basic copper sulfate and sulfur.

Additional suitable plant growth regulators include spiroxamine; cyflufenamide; cymoxanil; metrafenone; organo(thio)phosphates selected from acephate, azamethiphos, azinphos-methyl, chlorpyrifos, chlorpyrifos-methyl, chlorfenvinphos, diazinon, dichlorvos, dicrotophos, dimethoate, disulfoton, ethion, fenitrothion, fenthion, isoxathion, malathion, methamidophos, methidathion, methyl-parathion, mevinphos, monocrotophos, oxydemeton-methyl, paraoxon, parathion, phenthoate, phosalone, phosmet, phosphamidon, phorate, phoxim, pirimiphos-methyl, profenofos, prothiofos, sulprophos, tetrachlorvinphos, terbufos, triazophos and trichlorfon; carbamates selected from alanycarb, aldicarb, bendiocarb, benfuracarb, carbaryl, carbofuran, carbosulfan, fenoxycarb, furathiocarb, methiocarb, methomyl, oxamyl, pirimicarb, propoxur, thiodicar and triazamate; and pyrethroids selected from allethrin, bifenthrin, cyfluthrin, cyhalothrin, cy-phenothrin, cypermethrin, alpha-cypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, tau-fluvalinate, tefluthrin, tetramethrin, tralomethrin, transfluthrin and profluthrin, dimefluthrin.

Additional suitable plant growth regulators include (a) chitin synthesis inhibitors that are selected from the benzoylureas chlorfluazuron, diflubenzuron, flucycloxuron, flufenoxuron, hexaflumuron, lufenuron, novaluron, teflubenzuron, triflumuron; buprofezin, diofenolan, hexythiazox, etoxazole and clofentazine; (b) ecdysone antagonists that are selected from halofenozide, methoxyfenozide, tebufenozide and azadirachtin; (c) juvenoids that are selected from pyriproxyfen, methoprene and fenoxycarb; and (d) lipid biosynthesis inhibitors that are selected from spi-rodiclofen, spiromesifen and spirotetramat.

Additional suitable plant growth regulators include nicotinic receptor agonists/antagonists compounds selected from clothianidin, dinotefuran, imidacloprid, thiamethoxam, nitenpyram, acetamiprid, thiacloprid; and the thiazol compound of formula (I):

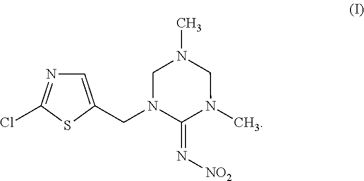 [SMILES: CN1CN(C)/C(=N\[N+](=O)[O-])N(Cc2cnc(Cl)s2)C1]

Additional suitable plant growth regulators include chlorfenapyr; cyromazine; indoxacarb; piperonyl butoxide; METI I compounds selected from fenazaquin, pyridaben, tebufenpyrad, tolfenpyrad and flufenerim; METI II and III compounds selected from acequinocyl, fluacyprim and hydramethylnon; oxidative phosphorylation inhibitor compounds selected from cyhexatin, diafenthiuron, fenbutatin oxide and propargite; and GABA antagonist compoundsselected from acetoprole, endosulfan, ethi-prole, fipronil, vaniliprole, pyrafluprole, pyriprole and the phenylpyrazole compound of formula (II):

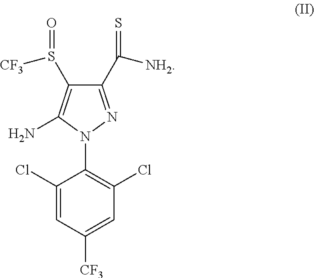 [SMILES: NC(=S)c1nn(-c2c(Cl)cc(C(F)(F)F)cc2Cl)c(N)c1S(=O)C(F)(F)F]

Additional suitable plant growth regulators include benclothiaz, bifenazate, cartap, flonicamid, pyridalyl, pymetrozine, sulfur, thiocyclam, flubendiamide, cyenopyrafen, flupyra-zofos, cyflumetofen, amidoflumet, the aminoquinazolinone compound of formula r (III):

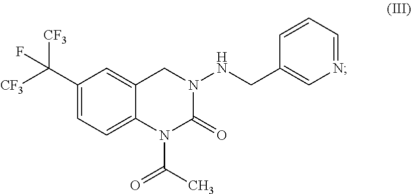 [SMILES: CC(=O)N1C(=O)N(NCc2cccnc2)Cc2cc(C(F)(C(F)(F)F)C(F)(F)F)ccc21]

and anthranilamide compounds of formula r (IV):

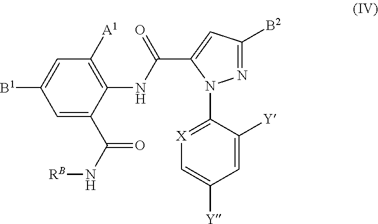

wherein A¹ is CH₃, Cl, Br, or I; X is C—H, C—Cl, C—F or N; Y′ is F, Cl, or Br, Y″ is F, Cl, or CF₃; B¹ is hydrogen, Cl, Br, I, or CN; B² is Cl, Br, CF₃, OCH₂CF₃, or OCF₂H, and R^{B} is hydrogen, CH₃ or CH(CH₃)₂.

Additional suitable plant growth regulators include lipid biosynthesis inhibitors selected from chlorazifop, clodinafop, clofop, cyhalofop, diclofop, fenoxaprop, fenoxaprop-p, fenthiaprop, fluazifop, fluazifop-P, haloxyfop, haloxyfop-P, isoxapyrifop, metamifop, propaquizafop, quizalofop, quizalofop-P, trifop, alloxydim, butroxydim, clethodim, cloproxydim, cycloxydim, profoxydim, sethoxydim, tepraloxydim, tralkoxydim, butylate, cycloate, diallate, dimepiperate, EPTC, esprocarb, ethiolate, isopolinate, methiobencarb, molinate, orbencarb, pebulate, prosulfocarb, sulfallate, thiobencarb, tiocarbazil, triallate, vernolate, benfuresate, ethofumesate, bensulide and pinoxaden; ALS inhibitors selected from amidosulfuron, azimsulfuron, bensulfuron, chlorimuron, chlorsulfuron, cinosulfuron, cyclosulfamuron, ethametsulfuron, ethoxysulfuron, flazasulfuron, flupyrsulfuron, foramsulfuron, halosulfuron, imazosulfuron, iodosulfuron, mesosulfuron, metsulfuron, nicosulfuron, oxasulfuron, primisulfuron, prosulfuron, pyrazosulfuron, rimsulfuron, sulfometuron, sulfosulfuron, thifensulfuron, triasulfuron, tribenuron, trifloxysulfuron, triflusulfuron, tritosulfuron, imazamethabenz, imazamox imazapic, imazapyr, imazaquin, imazethapyr, cloransulam, diclosulam, florasulam, flumetsulam, metosulam, penoxsulam, bispyribac, pyriminobac, propoxycarbazone, flucarbazone, pyribenzoxim, pyriftalid, pyrithiobac, flucetosulfuron, orthosulfamuron, pyrimisulfan; and photosynthesis inhibitors selected from atraton, atrazine, ametryne, aziprotryne, cyanazine, cyanatryn, chlorazine, cyprazine, desmetryne, dimethametryne, dipropetryn, eglinazine, ipazine, mesoprazine, methometon, methoprotryne, procyazine, proglinazine, prometon, prometryne, propazine, sebuthylazine, secbumeton, simazine, simeton, simetryne, terbumeton, terbuthy-lazine, terbutryne, trietazine, ametridione, amibuzin, hexazinone, isomethiozin, metamitron, metribuzin, bromacil, isocil, lenacil, terbacil, brompyrazon, chlorida-zon, dimidazon, desmedipham, phenisopham, phenmedipham, phenmedipham-ethyl, benzthiazuron, buthiuron, ethidimuron, isouron, methabenzthiazuron, monoisouron, tebuthiuron, thiazafluoron, anisuron, buturon, chlorbromuron, chlo-returon, chlorotoluron, chloroxuron, difenoxuron, dimefuron, diuron, fenuron, fluometuron, fluothiuron, isoproturon, linuron, methiuron, metobenzuron, meto-bromuron, metoxuron, monolinuron, monuron, neburon, parafluoron, phenobenzuron, siduron, tetrafluoron, thidiazuron, cyperquat, diethamquat, difenzo-quat, diquat, morfamquat, paraquat, bromobonil, bromoxynil, chloroxynil, iodobonil, ioxynil, amicarbazone, bromofenoxim, flumezin, methazole, bentazone, propanil, pentanochlor, pyridate, and pyridafol.

Additional suitable plant growth regulators include protoporphyrinogen-IX oxidase inhibitors selected from acifluorfen, bifenox, chlomethoxyfen, chlornitrofen, ethoxyfen, fluorodifen, fluoroglycofen, fluoronitrofen, fomesafen, furyloxyfen, halosafen, lactofen, nitrofen, nitrofluorfen, oxyfluorfen, fluazolate, pyraflufen, cinidon-ethyl, flumiclorac, flumioxazin, flumipropyn, fluthiacet, thidiazimin, oxadiazon, oxadiargyl, azafenidin, carfentrazone, sulfentrazone, pentoxazone, benzfendizone, butafenacil, pyraclonil, profluazol, flufenpyr, flupropacil, nipyraclofen, etnipromid, and bencarbazone; bleacher herbicides selected from metflurazon, norflurazon, flufenican, diflufenican, picolinafen, beflubutamid, fluridone, fluorochloridone, flurtamone, mesotrione, sulcotrione, isoxachlortole, isoxaflutole, benzofenap, pyrazolynate, pyrazoxyfen, benzobicyclon, amitrole, clomazone, aclonifen, 4-(3-trifluoromethyl-phenoxy)-2-(4-trifluoromethylphenyl)pyrimidine, topramezone, 4-hydroxy-3-{[2-methyl-6-(trifluoromethyl)-3-pyridinyl]carbonyl}bicyclo[3.2.1]oct-3-en-2-one, 4-hydroxy-3-{[2-(2-methoxyethoxy)methyl-6-(trifluoro-methyl)-3-pyridinyl]carbonyl}bicylo[3.2.1]oct-3-en-2-one, 4-hydroxy-3-[4-(methylsulfonyl)-2-nitrobenzoyl]bicyclo[3.2.1]-oct-3-en-2-one, 2-[2-chloro-4-(methylsulfonyl)-3-[(2,2,2-trifluoroethoxy)methyl]benzoyl]-3-hydroxy-2-cyclohexen-1-one and pyrasulfotole.

Additional suitable plant growth regulators include glyphosate in its acid form or as a derivative thereof, such as the mono isopropylammonium salt, the sodium salt, trimesium salt (sulfosate) or a mixture thereof; glutamine synthase inhibitors selected from glufosinate and bilanaphos; asulam; mitose inhibitors selected from benfluralin, butralin, dinitramine, ethalfluralin, fluchloralin, isopropalin, methalpropalin, nitralin, oryzalin, pendimethalin, prodiamine, profluralin, trifluralin, amiprofos-methyl, butamifos, dithiopyr, thia-zopyr, propyzamide, tebutam, chlorthal, carbetamide, chlorbufam, chlorpropham and propham; VLCFA inhibitors selected from acetochlor, alachlor, butachlor, bu-tenachlor, delachlor, diethatyl, dimethachlor, dimethenamid, dimethenamid-P, metazachlor, metolachlor, S-metolachlor, pretilachlor, propachlor, propisochlor, prynachlor, terbuchlor, thenylchlor, xylachlor, allidochlor, CDEA, epronaz, diphenamid, napropamide, naproanilide, pethoxamid, flufenacet, mefenacet, fentrazamide, anilofos, piperophos, cafenstrole, indanofan and tridiphane; cellulose biosynthesis inhibitors selected from dichlobenil, chlorthiamid, isoxaben and flupoxam; decoupler herbicides selected from dinofenate, dinoprop, dinosam, di-noseb, dinoterb, DNOC, etinofen and medinoterb.

Additional suitable plant growth regulators include auxin herbicides selected from clomeprop, 2,4-D, 2,4,5-T, MCPA, MCPA thioethyl, dichlorprop, dichlorprop-P, mecoprop, mecoprop-P, 2,4-DB, MCPB, chloramben, dicamba, 2,3,6-TBA, tricamba, clopyralid, fluoroxypyr, picloram, tri-clopyr, benazolin, aminopyralid, quinclorac, and quinmerac; auxin transport inhibitors selected from naptalam and diflufenzopyr; benzoylprop, flamprop, flamprop-M, bromobutide, chlorflurenol, cinmethylin, methyldymron, etobenzanid, fosamine, metam, pyributicarb, oxazi-clomefone, dazomet, triaziflam, methyl bromide, and endothal; inhibitors of ethylene biosynthesis which block the conversion of ACC into ethylene selected from Co²⁺ or Ni²⁺ ions; radical-scavenging phenolic substances including n-propyl gallate; polyamines including putrescine, spermine, spermidine; structural ACC analogs including alpha-aminoisobutyric acid, L-aminocyclopropene-1-carboxylic acid; salicylic acid including its synthetic analogon acibenzolar-5-methyl; structural analogs of ascorbic acid which act as inhibitors of ACC oxidase including prohexadione-Ca or trinexapac-ethyl; triazolyl compounds as inhibitors of cytochrome P-450-dependent monooxygenase; inhibitors of the action of ethylene 2,5-norbornadiene, and 3-amino-1,2,4-triazole or Ag²⁺ ions; and ethylene biosynthesis inhibitors which inhibit the conversion of S-adenosyl-L-methionine into 1-aminocyclopropane-1-carboxylic acid (ACC) including derivatives of vinylglycine, hydroxylamines, or oxime ether.

### EXAMPLES

### Example 1

### Sample Preparation

Steps to make 1-MCP powder dispersion—The samples are prepared as follow:

(a) Charging air milled HAIP (1-methylcyclopropene/alpha-cyclodextrin complex) powder and polymer resin into a vessel, then the vessel is placed in a oil bath and heated to temperature slightly over melting point of the resin, the HAIP powder is evenly dispersed into the resin under shearing, thus a viscous dispersion is obtained;
(b) Adding silica powder into oil, followed by shearing under ambient temperature to get a uniform mixture. Then heat the mixture to the temperature slightly over the melting point of resin;
(c) Adding HAIP powder dispersion in oil from step (a), into mixture of oil and silica particles from step (b). Disperse HAIP powder dispersion in oil from step (a) into mixture of oil and silica particles from step (b) by high speed shearing at the temperature slightly above melting point of the resin; and
(d) Consolidating the dispersed particles by cooling.

### Example 2

### Test Methods

The release of diluted samples is investigated as follow: About 0.2 g sample and 0.04 g of surfactants are charged into a vial of 22 ml and the mixture is blended evenly by shearing. Then 2 ml water is added to the vial and milk like emulsion is obtained after shearing. A series of diluted samples are prepared using this method. After placing the vials at ambient temperature for certain period of time, the sample can be analyzed by gas chromatography to observe concentration variation of 1-MCP and to track and detect the effective release of 1-MCP. The heater on the oven is then turned off, with the temperature on the oven about 40° C., while ambient temperature was about 22° C. The head space analysis measurement is taken after a given time period after the sample is diluted with water. Each vial is sampled once, that is, a new vial is used to obtain each data point for time release studies.

From the measure concentration of 1-MCP in the headspace, the amount of sample added to the vial and the theoretical 1-MCP content in the sample, the fraction of the total amount of 1-MCP in the vial that resides in the headspace can be calculated and reported as a percentage based on the amount of 1-MCP added to the vial.

The release of 1-MCP from the samples is compared to the release of 1-MCP from HAIP powder. For measuring the release of 1-MCP from HAIP, about 20 mg of HAIP powder is weighed into a 22 ml headspace vial and 2 ml water is injected. The head space analysis measurement is taken under the same conditions described above.

### Example 3

### Preparation of Sample #1

Sample #1 is prepared as the following:

(1) 26.04 g polyester resin is added to a vessel, and the vessel is heated to the melting point of the polyester, i.e., 60° C. After all the resin melt, 6.47 g HAIP powder is charged, and the mixture is thoroughly mixed by shearing for about ten minutes, then HAIP powder is evenly dispersed in the melt resin to obtain viscous dispersion.

(2) 64.45 g mineral oil and 3.04 g silica powder are charged into a vessel, and then the mixture is thoroughly mixed by shearing, followed by heating to 60° C.

(3) HAIP dispersion (1) is blended with Pickering particle dispersion (2) under high shearing of about 1000 rpm for about three minutes at about 60° C.; the resin is dispersed into mineral oil to form spheres wherein HAIP imbedded. Then the dispersion is cooled down to ambient temperature.

### Example 4

### Preparation of Sample #2

Sample #2 is prepared as the following:

(1) 28.75 g polyester resin is added to a vessel, and the vessel is heated to the melting point of the polyester, i.e., 60° C. After all the resin melt, 7.19 g HAIP powder is charged, and the mixture is thoroughly mixed by shearing for about ten minutes, then HAIP powder is evenly dispersed in the melt resin to obtain viscous dispersion.

(2) 60.15 g mineral oil and 3.91 g silica powder are charged into a vessel, and then the mixture is thoroughly mixed by shearing, followed by heating to 60° C.

(3) HAIP dispersion (1) is blended with Pickering particle dispersion (2) under high shearing of about 3400 rpm for about three minutes at about 60° C.; the resin is dispersed into mineral oil to form spheres wherein HAIP imbedded. Then the dispersion is cooled down to ambient temperature.

### Example 5

### Preparation of Sample #3

Sample #3 is prepared as the following:

(1) 22.98 g polyester resin is added to a vessel, and the vessel is heated to the melting point of the polyester, i.e., 60° C. After all the resin melt, 5.74 g HAIP powder is charged, and the mixture is thoroughly mixed by shearing for about ten minutes, then HAIP powder is evenly dispersed in the melt resin to obtain viscous dispersion.

(2) 67.01 g Isopar M and 4.27 g silica powder are charged into a vessel, and then the mixture is thoroughly mixed by shearing, followed by heating to 60° C.

(3) HAIP dispersion (1) is blended with Pickering particle dispersion (2) under high shearing of about 3400 rpm for about three minutes at about 60° C.; the resin is dispersed into Isopar M to form spheres wherein HAIP particles imbedded. Then the dispersion is cooled down to ambient temperature.

### Example 6

### Preparation of Sample #4

Sample #4 is prepared as the following:

(1) 23.27 g polyester resin is added to a vessel, and the vessel is heated to the melting point of the polyester, i.e., 60° C. After all the resin melt, 5.83 g HAIP powder is charged, and the mixture is thoroughly mixed by shearing for about ten minutes, then HAIP powder is evenly dispersed in the melt resin to obtain viscous dispersion.

(2) 65.85 g Isopar M, 4.20 g silica R805 and 0.85 g D17 powder are charged into a vessel, and then the mixture is thoroughly mixed by shearing, followed by heating to 60° C.

(3) HAIP dispersion (1) is blended with Pickering particle dispersion (2) under high shearing of about 3400 rpm for about three minutes at about 60° C.; the resin is dispersed into Isopar M to form spheres wherein HAIP particles imbedded. Then the dispersion is cooled down to ambient temperature.

### Example 7

### Preparation of Sample #5

Sample #5 is prepared as the following:

(1) 22.88 g polyester resin is added to a vessel, and the vessel is heated to the melting point of the polyester, i.e., 60° C. After all the resin melt, 5.72 g HAIP powder is charged, and the mixture is thoroughly mixed under shearing for about ten minutes, then HAIP powder is evenly dispersed in the melt resin to obtain viscous dispersion.

(2) 67.37 g mineral oil, 0.81 g Unithox 720, 1.88 g Unithox 750 and 1.34 g SDBS are charged into a vessel, and then the mixture is heated to about 110° C. After that, the mixture is thoroughly mixed by shearing, then cool down to 60° C. to obtain surfactant dispersion.

(3) HAIP dispersion (1) is blended with surfactant dispersion (2) under high shearing for about three minutes at about 60° C.; the resin is dispersed into mineral oil to form particles wherein HAIP particles imbedded. Then the dispersion is cooled down to room temperature.

### Example 8

### Formulation

Formulations of samples are summarized in Table 1.

| | | | | | | Comparative |
|---|---|---|---|---|---|---|
| Ingredients | Sample #1 | Sample #2 | Sample #3 | Sample #4 | Sample #5 | sample 1 |
| HAIP powder^{a} | 6.47 g | 7.19 g | 5.74 g | 5.83 g | 5.72 g | Only this |
| Polymer resin | 26.04 g | 28.75 g | 22.98 g | 23.27 g | 22.88 g | powder |
| Oil^{b} | 64.45 g | 60.15 g | 67.01 g | 65.85 g | 67.37 g | |
| Silica powder R805 | 3.04 | 3.91 | 4.27 g | 4.20 g | / | |
| Silica powder D17 | / | / | / | 0.85 g | / | |
| Unithox 720 | / | / | / | / | 0.81 g | |
| Unithox 750 | / | / | / | / | 1.88 g | |
| SDBS | / | / | / | / | 1.34 g | |
| Total weight | 100.00 g | 100.00 g | 100.00 g | 100.00 g | 100.00 g | |

^{a}HAIP is 1-MCP complex powder contains about 4.5% 1-methylcyclopropene.
^{b}For Sample #1, #2 and #5, the oil used is mineral oil; for Sample #3 and #4, the oil used is is Isopar M.

### Example 9

### Comparative Samples

Comparative samples are prepared as the following:

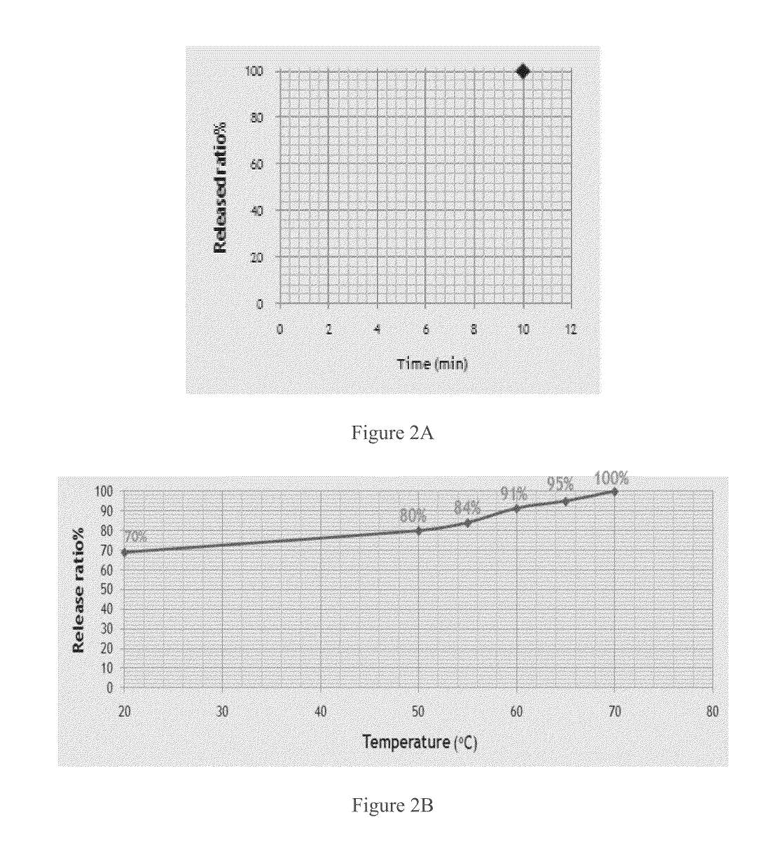

(1) HAIP+water system: 20 mg HAIP powder is sealed in a vial, and 2 ml water is injected, 1-MCP concentration in head space is analyzed by gas chromatography. FIG. 2A shows the release profile of 1-MCP from HAIP powder upon contact with water. As shown in FIG. 2A, at ambient temperature, 1-MCP is released and diffused completely in about ten minutes from HAIP upon contact with water.

HAIP+oil+water system: 20 mg HAIP powder is first blended with 250 mg oil under shearing, then the mixture and surfactant are sealed in a vial, and water is injected, then the vial is shaken to obtain a uniform emulsion. After that, the diluted samples are hold at different temperatures (22, 50, 55, 60, 65 and 70° C.) for 30 minutes. 1-MCP concentration in head space is analyzed by gas chromatography at corresponding temperatures. FIG. 2B shows the release profile of 1-MCP. As shown in FIG. 2B, after emulsified samples are hold at 22, 50, 55, 60, 65 and 70° C. for 30 minutes, released 1-MCP into head space are 70%, 80%, 84%, 91%, 95% and 100%, respectively. That is, the release ratios increase with the increase of temperature, and under current conditions only 70% 1-MCP released into head space at ambient temperature, and even if hold the sample at this temperature for longer time the release ratio is still ˜70%.

### Example 10

### Release Profiles of Test Samples

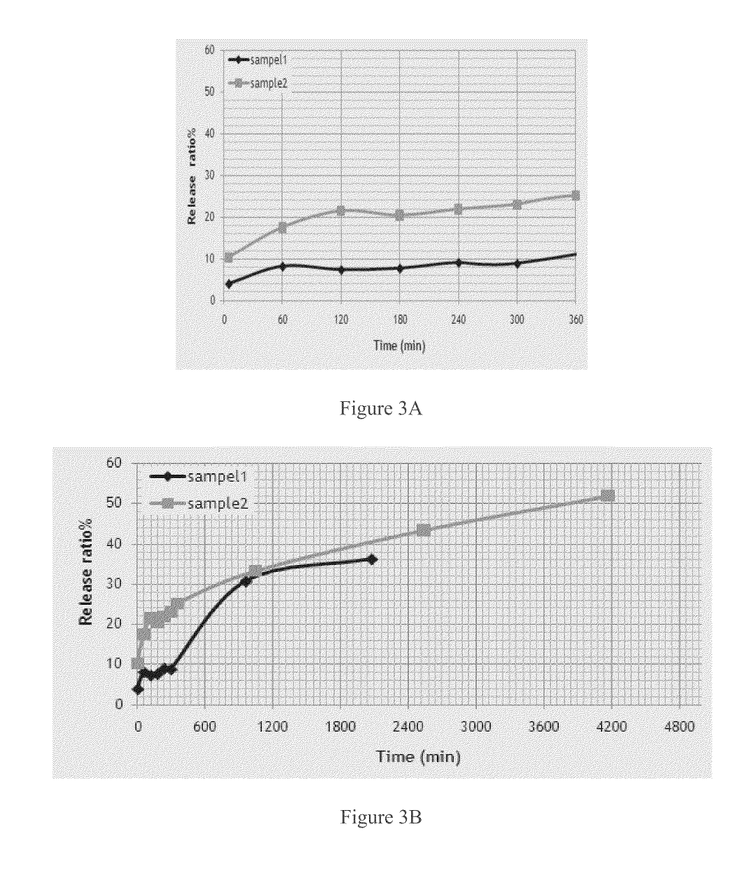

FIG. 3A shows a representative release profile of 1-MCP from the diluted Sample #1 and Sample #2. As shown in FIG. 3A, initial release ratio is ˜4% for Sample #1 and ˜10% for Sample #2; within 300 minutes there are no big changes in release ratio, less than 10% for Sample #1 and about 20% for Sample #2. For longer time, as shown in FIG. 3B, the release ratio increase over time, 1-MCP is released continually even after contact with water for about 4,000 minutes.

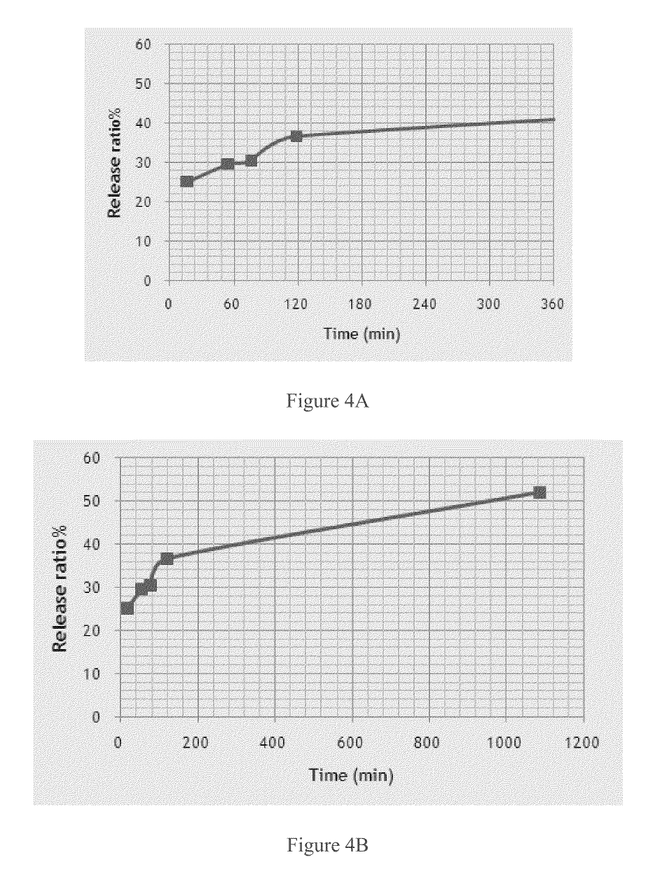

FIG. 4A shows a representative release profile of 1-MCP from the diluted Sample #5. As shown in FIG. 4A, initial release ratio is −25%; within 5-300 minutes release ratio increased from −25% to −41%. For longer time, as shown in FIG. 4B, the release ratio increase over time, 1-MCP is released continually even after contact with water for about 1,100 minutes.

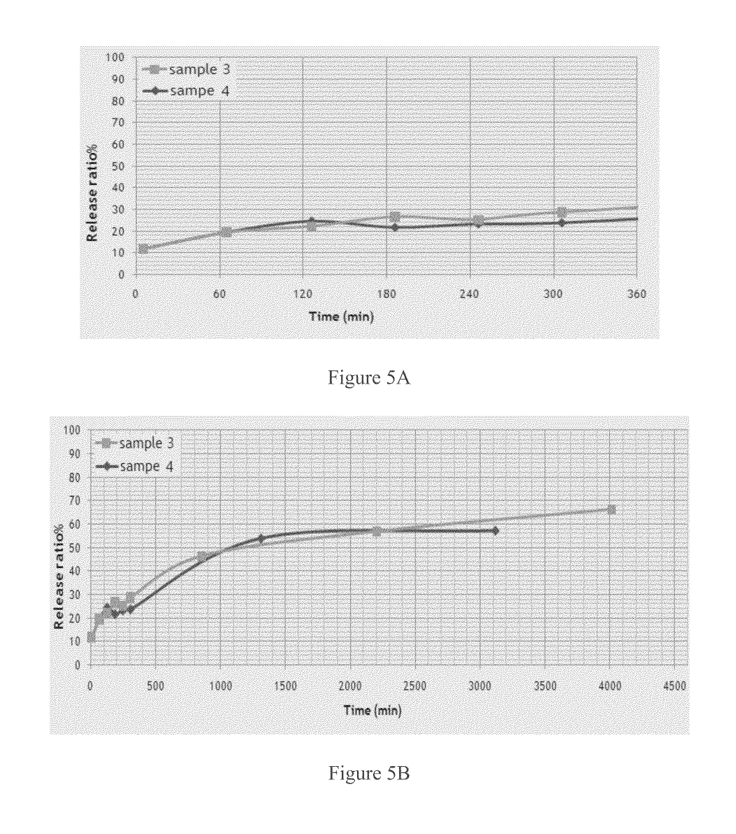

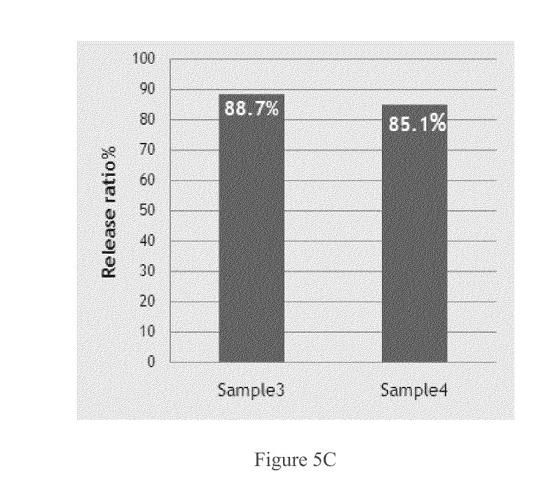

FIGS. 5A and 5B show representative release profiles of 1-MCP from the diluted Sample #3 and Sample #4. As shown in FIGS. 5A and 5B, within 240 minutes the release ratio for both samples is about 23% and there are no big changes in release ratio. For longer time, as shown in FIG. 5B, the release ratio increase over time, 1-MCP is released continually even after contact with water for about 4,000 minutes. As hold the diluted samples at 70° C. for 30 minutes, the release ratio is about 88.7% for Sample #3, 85.1% for Sample #4, as shown in FIG. 5C.

In view of the above, the matrix encapsulated composition of the present invention is convenient for use in liquid form. Compared to HAIP powder form, HAIP particles are double protected by resin matrix spheres and hydrophobic Pickering particles layer around spheres according to the composition provided. As the sample is diluted with water, water needs to go through the hydrophobic particle layer and penetrate into the resin matrix, interacts with the imbedded HAIP particles, and releases 1-MCP from HAIP. Low initial release ratio can be achieved within several hours after dilution, slow release of 1-MCP can be achieved for longer time and give longer application time; and also this allows uniform delivery of 1-MCP upon water dilution, permitting effective and consistent use in field conditions. Compared to oil droplets encapsulation formulation in which 1-MCP content is very low (less than 50 ppm) since 1-MCP gas is used, 1-MCP content can increase to more than 200,000 ppm since HAIP powder can be used to conduct the encapsulation in this invention.

### Example 11

### SEM Images of Test Samples

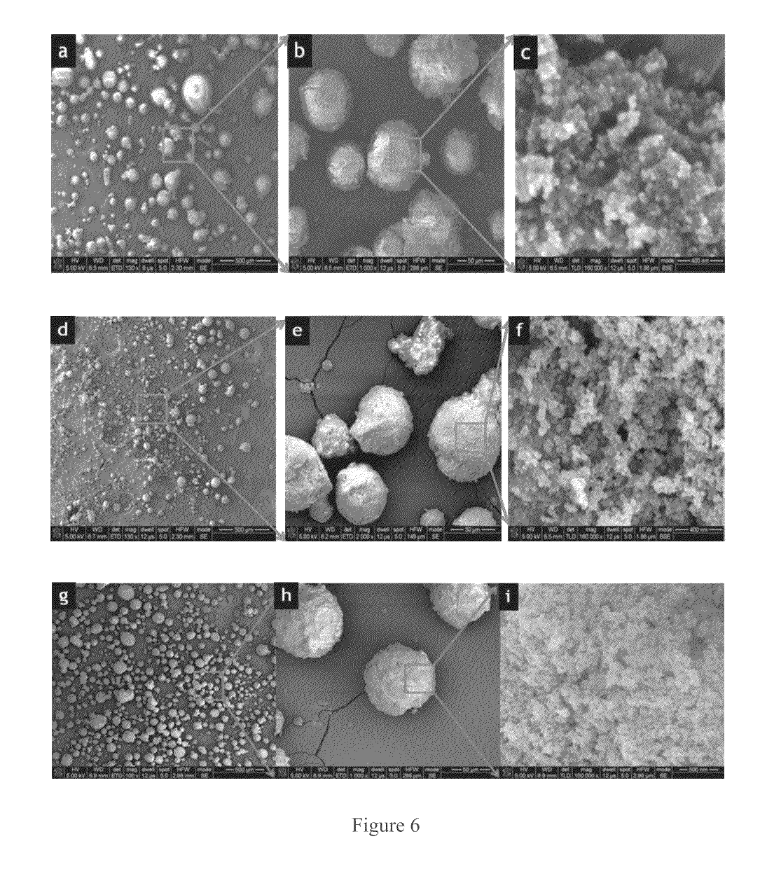

SEM image of the dispersions can be obtained for test samples provided herein. As shown in FIG. 6, the particle sizes of Sample #1, Sample #2 and Sample #4 are about 30-250 microns, 20-100 microns, and 20-120 microns, respectively. Furthermore, for all these samples the matrix spheres are covered by hydrophobic silica particles. For 1-MCP release study, the sample and some surfactants are sealed in a vial, and water is injected, then the vial is shaken to obtain a uniform emulsion. The head space analysis measurement is taken after a given time period after dilution.

1.-30. (canceled)

31. A method for preparing a composition, comprising,
(a) blending an active ingredient with resin at a temperature higher than melting point of the resin;
(b) dispersing the blend of step (a) into an oil medium containing hydrophobic particles; and
(c) consolidating Pickering particles by cooling to a temperature lower than the melting point of the resin.

32. The method of claim 31, wherein the oil medium comprises a mixture of alkanes of C14 to C50, or a distillate of petroleum.

33. The method of claim 31, wherein the oil medium comprises mineral oil, light mineral oils, Isopar oil, Unipar oil and other hydrocarbon oils, edible oils, or combinations thereof.

34. The method of claim 31, wherein the temperature lower than the melting point of the resin is ambient temperature.

35. The method of claim 31, wherein ratio of the Pickering particles to the oil medium is from about 1:5 to about 1:25.

36. The method of claim 31, wherein ratio of the Pickering particles to the oil medium is from about 1:10 to about 1:24.

37. The method of claim 31, wherein ratio of the resin matrix to the oil medium is from about 2:1 to about 1:100.

38. The method of claim 31, wherein ratio of the resin matrix to the oil medium is from about 1:1 to about 1:100.

39. The method of claim 31, wherein the active ingredient comprises a volatile compound.

40. The method of claim 39, wherein the volatile compound comprises a cyclopropene.

41. The method of claim 40, wherein the cyclopropene is of the formula: 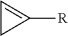
wherein R is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy.

42. The method of claim 41, wherein R is C₁₋₈ alkyl.

43. The method of claim 42, wherein R is methyl.

44. The method of claim 40, wherein the cyclopropene is of the formula: 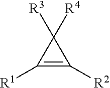
wherein R¹ is a substituted or unsubstituted C₁-C₄ alkyl, C₁-C₄ alkenyl, C₁-C₄ alkynyl, C₁-C₄ cylcoalkyl, cylcoalkylalkyl, phenyl, or napthyl group; and R², R³, and R⁴ are hydrogen.

45. The method of claim 44, wherein the cyclopropene comprises 1-methylcyclopropene (1-MCP).

46.-47. (canceled)
